(19) United States
(12) Patent Application Publication
(10) Pub. No.: US 2017/0221646 A1
(43) Pub. Date: Aug. 3, 2017

(54) NITROGEN-CONTAINING POROUS CARBON MATERIAL, AND CAPACITOR AND MANUFACTURING METHOD THEREOF

(71) Applicant: TAIWAN CARBON NANO TECHNOLOGY CORPORATION, MIAOLI COUNTY (TW)

(72) Inventors: Kuang-Che Lee, MIAOLI COUNTY (TW); Po-Yen Liao, MIAOLI COUNTY (TW); Jr-Wei Peng, MIAOLI COUNTY (TW); Chun-Hsien Tsai, MIAOLI COUNTY (TW); Chun-Jung Tsai, MIAOLI COUNTY (TW); Ting-Chuan Lee, MIAOLI COUNTY (TW)

(21) Appl. No.: 15/402,487

(22) Filed: Jan. 10, 2017

(30) Foreign Application Priority Data
Feb. 1, 2016 (TW) 105103168

(51) Int. Cl. H01G 11/42; B29C 43/02; H01G 11/40; H01G 11/36; C04B 38/06; C04B 35/532; C04B 35/634; C04B 35/638; C04B 35/64; B29C 67/20; H01G 11/26

(52) U.S. Cl. CPC H01G 11/42; B29C 67/205; B29C 43/02; H01G 11/40; H01G 11/36; H01G 11/26; C04B 35/532; C04B 35/634; C04B 35/638; C04B 35/64; C04B 38/067; B29K 2079/00

(57) ABSTRACT

A nitrogen-containing porous carbon material, and a capacitor and a manufacturing method thereof are provided. A carbon material, a macromolecular material and a modified material are mixed into a preform. The modified material includes nitrogen. A formation process is performed on the preform to obtain a formed object. High-temperature sintering is performed on the formed object to decompose and remove a part of the macromolecular material, while the other part of the macromolecular material and the carbon material together form a backbone structure including a plurality of pores. As such, the nitrogen becomes attached to the backbone structure to form a hydrogen-containing functional group to further obtain the nitrogen-containing porous carbon material. The nitrogen-containing porous carbon material may form a first nitrogen-containing porous carbon plate and a second nitrogen-containing porous carbon plate, which are placed in seawater to form a storage capacitor for seawater.

### FIELD OF THE INVENTION

The present invention relates to a porous carbon material, and particularly to a nitrogen-containing porous carbon material, and a capacitor and manufacturing method thereof.

### BACKGROUND OF THE INVENTION

A porous carbon material refers to a carbon material having different pore diameters, which may range from nano-scale diameters substantially equal to the size of molecules to micron-scale diameters suitable for microorganism proliferation and activities. Further, porous carbon materials feature a series of advantages of being heat resistant, acid alkali resistant, electric conductive and heat conductive, and are thus extensively applied in fields of gas and liquid refinement, water processing, air purification, catalytic materials, electronic energy materials, and bio-engineered materials.

For example, the U.S. Patent Publication No. US 2014/0118884 A1, “Porous Carbon Material and Manufacturing Method thereof and Supercapacitor”, discloses a porous carbon material. The above disclosure includes a plurality of a macropores, a plurality of mesopores and a plurality of micropores. Wherein, each of the macropores has a diameter larger than 50 nanometers, each of the mesopores has a diameter ranging from 2 nanometers to 50 nanometers, and each of the micropores has a diameter less than 2 nanometers. A distribution proportion of the pore volume of the macropores ranges from 10-25%, a distribution proportion of the pore volume of the mesopores ranges from 20-80%, and a distribution proportion of the pore volume of the micropores ranges from 0.01-20%. By adjusting the distribution proportions of the pore volumes of the macropores, mesopores and micropores, the surface area may achieve an optimum value to further enhance properties including electrical conductivity, heat conductivity and reduction oxidation of the porous carbon material.

However, when the surface area reaches an optimum value, the electrical conductivity, heat conductivity and reduction oxidation properties also reach certain values and cannot be further enhanced.

Therefore, there is a need for a solution that further enhances properties of porous carbon materials to allow porous carbon materials be even more application advantageous.

### SUMMARY OF THE INVENTION

Therefore, it is a primary object of the present invention to solve the issue of a conventional porous carbon material with properties that can hardly be further enhanced.

To achieve the above object, the present invention provides a manufacturing method of a nitrogen-containing porous carbon material. The manufacturing method includes following steps.

In step S1, a carbon material, a macromolecular material and a modified material are mixed into a preform. The modified material includes nitrogen, and is selected from a group consisting of amine, amide, a nitrogen-containing heterocyclic compound and an ammonium salt. In the preform, a weight percentage of the carbon material is between 30% and 85%, a weight percentage of the macromolecular material is between 10% and 60%, and a weight percentage of the modified material is between 3% and 40%.

In step S2, a formation process is performed on the preform to obtain a formed body.

In step S3, high-temperature sintering is performed on the formed body, such that a part of the macromolecular material is decomposed and removed, one other part of the macromolecular material and the carbon material together form a backbone structure including a plurality of pores, and the nitrogen in the modified material becomes attached to the backbone structure to form a nitrogen-containing functional group to further obtain a nitrogen-containing porous carbon material.

To achieve the above object, the present invention further provides a nitrogen-containing porous carbon material manufactured by the foregoing method. The nitrogen-containing porous carbon material includes the backbone structure, is mostly composed of carbon, and further includes the pores and the functional group bonded with the backbone structure.

To achieve the above object, the present invention further provides a storage capacitor for seawater. The storage capacitor includes a first nitrogen-containing porous carbon plate, a second nitrogen-containing porous carbon plate disposed at a distance from the first nitrogen-containing porous carbon plate, a first collector plate in contact with the first nitrogen-containing porous carbon plate, and a second collector plate in contact with the second nitrogen-containing porous carbon plate. The first nitrogen-containing porous carbon plate, the second nitrogen-containing porous carbon plate, the first collector plate and the second collector plate are disposed in seawater, and the first nitrogen-containing porous carbon plate and the second nitrogen-containing porous carbon plate are manufactured by the method of claim 1 of the appended claims. Sodium chloride in the seawater is decomposed into sodium ions and chlorine ions, which respectively enter the first nitrogen-containing porous carbon plate and the second nitrogen-containing porous carbon plate to store energy.

In conclusion, the present invention provides following features.

1. During the high-temperature sintering, a part of the macromolecular material is decomposed and removed, and the other part of the macromolecular material and the carbon material together form the backbone structure and the pores. With the modified material and a high temperature, the nitrogen-containing functional group is then formed. Thus, properties including electrical conductivity, heat conductivity, reduction oxidation, ion reduction oxidation and catalytic efficiency of the nitrogen-containing porous carbon material can be enhanced, thereby allowing the nitrogen-containing porous carbon material to be more advantageous for applications.

2. In a conventional storage capacitor, as electrodes are not in form of a block material, the electrodes need to be applied to a metal collector plate to form a layer-like or plate-like structure and be used. Further, as increasing the thickness of such electrodes is not easy, the area of the electrodes is frequently increased as an alternative when electrodes having larger volumes are needed, meaning that the area of the metal collector plate also needs to be correspondingly increased. In comparison, the nitrogen-containing porous carbon material obtained by the present invention has rigidity and is in form of a block material. When the nitrogen-containing porous carbon material is applied as electrodes for a storage capacitor, the thickness may be increased to achieve a larger volume. Therefore, the areas of the first collector plate and the second collector plate used can be reduced to further decrease the amount of material used, thereby significantly reducing the utilization and costs of metal collector plates.

3. With the nitrogen-containing functional group included in the first nitrogen-containing porous carbon plate and the second nitrogen-containing porous carbon plate, a certain amount of pseudo-capacitance can be obtained to increase the storage capability.

### BRIEF DESCRIPTION OF THE DRAWINGS

FIG. 1 is a schematic diagram of a manufacturing process of a nitrogen-containing porous carbon material of the present invention;

FIG. 2 is a schematic diagram of a partial section application schematic diagram according to a first embodiment of the present invention; and

FIG. 3 is an application schematic diagram according to a second embodiment of the present invention.

### DETAILED DESCRIPTION OF THE PREFERRED EMBODIMENTS

Details and technical contents of the present invention are given with the accompanying drawings below.

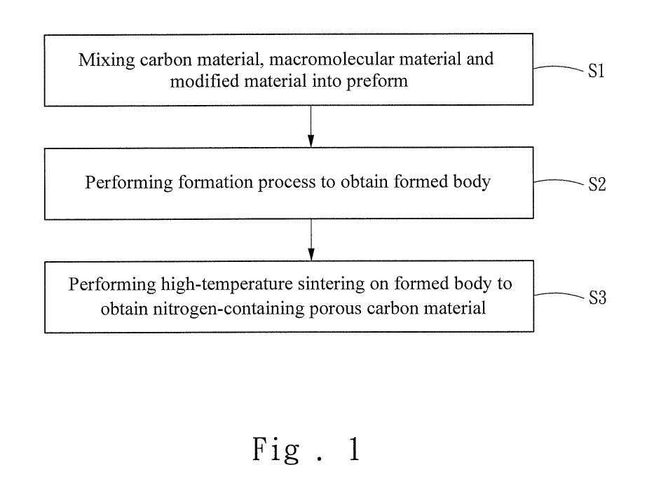

Referring to FIG. 1, the present invention provides a nitrogen-containing porous carbon material, and a capacitor and manufacturing method thereof. Referring to FIG. 1, the manufacturing method includes following steps.

In step S1, a carbon material, a macromolecular material and a modified material are mixed into a preform. For example, the carbon material may be at least one selected from a group consisting of carbon black, carbon fibers, carbon nanotubes, vapor grown carbon fibers, activated carbon, graphite, graphene, hollow carbon, soft carbon and hard carbon. For example, the macromolecular material may be at least one selected from a group consisting of phenol formaldehyde resin, epoxy, polyacrylonitrile (PAN), furan resin, polyvinyl alcohol (PVA), polyvinyl chloride (PVC), cellulose, polyvinylidene fluoride (PVDF), polytetrafluoroethene (PTFE) and fluorinated ethylene propylene (FEP). For example, the modified material may be selected from a group consisting of amine, amide, a nitrogen-containing heterocyclic compound and ammonium salt. Further, the modified material includes nitrogen. A general formula of the amine is R1-NH₂ or NH₂—R1-NH₂, where R1 may be a C3-C24 alkyl, e.g., propylamine, isopropylamine, hexylamine, octylamine, dodecylamine, 3-methyl-2-amino-pentane or ethylene diamine, or may be an aryl, e.g., aniline, toluidine, naphthylamine, biphenyl amine, benzidine, phenylene diamine, toluene diamine, 2,6-toluene diamine. A general formula of the amide is R2-CONH₂, where R2 may be C1-C18 alkyl or cycloalkyl, an aryl, e.g., phenyl or naphthyl, or an amino, and the acyl amine may be as acetamide, urea, or acetanilide. For example, the nitrogen-containing heterocyclic compound may be a five-membered heterocyclic ring or a six-membered heterocyclic ring. For example, the five-membered heterocyclic ring may be pyrrolidine or pyrrole; the six-membered heterocyclic ring may be pyridine, hexahydro-pyridine, 4-amino-2-oxo-pyrimidine, 2,4-dioxypyrimidine, melamine, 5-methyl-2, 4-dioxypyrimidine. A general formula of the ammonium salt is NH₄COO—R3, where R3 may be a hydroxy, e.g., ammonium bicarbonate, or an amino, e.g., ammonium carbamate, may be directly replaced by hydrogen or methyl, e.g., sodium carbonate or ammonium acetate, or may be an amine, e.g., sodium carbonate.

In the preform, a weight percentage of the carbon material is between 30% and 85%, a weight percentage of the macromolecular material is between 10% and 60%, and a weight percentage of the modified material is between 3% and 40%.

In step S2, a formation process is performed on the preform to obtain a formed body. In this embodiment, the formation process is causing the preform to be placed in a heating temperature between 100° C. and 200° C. and a formation pressure between 5 kgf/cm² and 200 kgf/cm². With the heating temperature and formation pressure, the density and three-dimensional structure of the preform are adjusted to form the block-like formed body. In one embodiment of the present invention, for example but not limited to, the formation process may be a hot pressing process, which simultaneously applies the heating temperature and the formation pressure. In another embodiment, the heating temperature may be first applied to the preform, followed by applying the formation pressure, e.g., a mold pressing process.

In step S3, high-temperature sintering is performed on the formed body, such that a part of the macromolecular material is decomposed and removed, and the other part of the macromolecular material and the carbon material together form a backbone structure including a plurality of pores, and the nitrogen in the modified material becomes attached to the backbone structure to form a nitrogen-containing functional group, thereby obtaining a nitrogen-containing porous carbon material. In the present invention, when the high-temperature sintering is performed, the other part of the macromolecular material serves the function as a binder, which sinters the carbon material into the backbone structure appearing as a three-dimensional network. In other words, the backbone structure is mostly formed by carbon. In the high-temperature sintering of the embodiment, the formed body is placed in a reducing atmosphere that may be argon or nitrogen, and in a heating temperature between 400° C. and 1200° C. to cause combustion and pyrolysis of the macromolecular material in the formed body. Thus, the nitrogen-containing porous carbon material is caused to have a porosity rate between 10% and 85%. The presence of the pores formed allows the surface area and internal space of the carbon material to increase. Further, with the nitrogen-containing functional group formed, properties including electrical conductivity, heat conductivity, reduction oxidation, ion reduction oxidation and catalytic efficiency of the nitrogen-containing porous carbon material can be enhanced, thereby allowing the nitrogen-containing porous carbon material to be more advantageous for applications.

During the process of the high-temperature sintering, an additional carbon material attached in between the carbon material may be further produced. For example, the additional carbon material may remain in between the carbon material after the combustion and pyrolysis of the macromolecular material or the modified material, or be provided by an additionally introduced carbon-containing atmosphere. Therefore, in the nitrogen-containing porous carbon material obtained at the end, the weight percentage of the carbon material is higher than that when the carbon is initially added, hence providing good electrical conductivity.

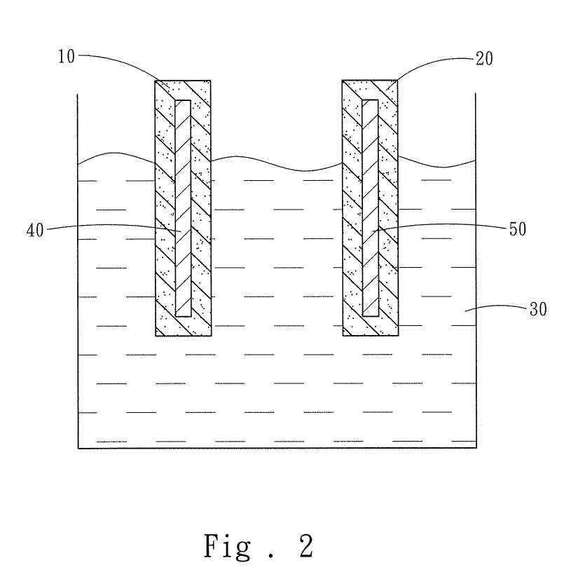

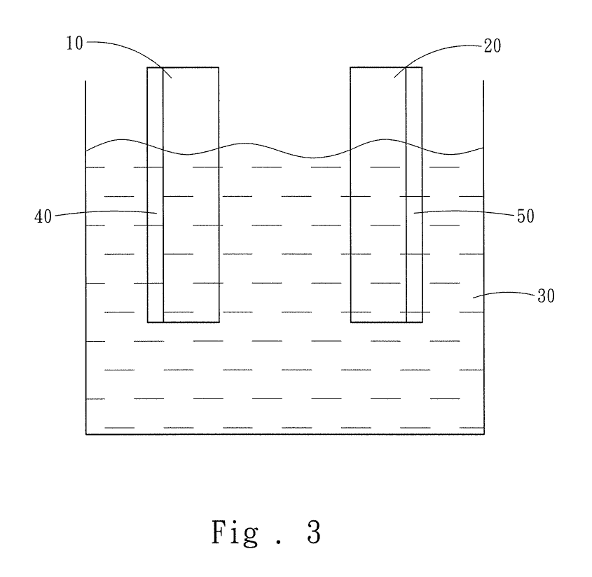

Referring to FIG. 2 and FIG. 3 showing a storage capacitor for seawater 30, the storage capacitor includes a first nitrogen-containing porous carbon plate 10, a second nitrogen-containing porous carbon plate 20, a first collector plate 40, a second collector plate 50 and seawater 30. The first nitrogen-containing porous carbon plate 10 is in contact with the first collector plate 40, and the second nitrogen-containing porous carbon plate 20 is in contact with the second collector plate 50. Further, the first nitrogen-containing porous carbon plate 10 and the second nitrogen-containing porous carbon plate 20 are manufactured by the foregoing manufacturing method, and are disposed at a distance from each other in the seawater 30 used as an electrolyte. When an external power is connected thereto, sodium chloride in the seawater 30 is decomposed into sodium ions and chloride ions, which respectively enter the first nitrogen-containing porous carbon plate 10 and the second nitrogen-containing porous carbon plate 20 to store energy.

Referring to FIG. 2 showing a first embodiment of the present invention, the first collector plate 40 and the second collector plate 50 are disposed in the first nitrogen-containing porous carbon plate 10 and the second nitrogen-containing porous carbon plate 20, respectively. As shown in FIG. 3 showing a second embodiment of the present invention, the first collector plate 40 is disposed at one side of the first nitrogen-containing porous carbon plate 10 away from the second nitrogen-containing porous carbon plate 20, and the second collector plate 50 is disposed at one side of the second nitrogen-containing porous carbon plate 20 away from the first nitrogen-containing porous carbon plate 10. It should be noted that, the arrangement of the above components of the present invention is not limited to the above examples.

As the first nitrogen-containing porous carbon plate 10 and the second nitrogen-containing porous carbon plate 20 are used as electrodes of a capacitor, and a separating film used in a conventional capacitor may be omitted, production costs of the capacitor may be reduced, the operating voltage may be increased and energy may be stored over an extended period of time. Further, because the first nitrogen-containing porous carbon plate 10 and the second nitrogen-containing porous carbon plate 20 include the nitrogen-containing functional group, a certain amount of pseudo-capacitance may be obtained to increase the storage capability. Further, the nitrogen-containing porous carbon material obtained by the method of the present invention has rigidity and is in a block-like form, whereas an electrode of the prior art is in a plate-like form and a stacked structure. Given a condition of electrodes of a same volume, in the present invention, increasing the thicknesses of the first nitrogen-containing porous carbon plate 10 and the second nitrogen-containing porous carbon plate 20 achieves a greater volume. Therefore, the utilization areas of the first collector plate 40 and the second collector plate 50 can be reduced to further decrease the amount of material used, thereby significantly reducing the utilization and costs of metal collector plates.

In conclusion, the present invention provides following features.

1. During the high-temperature sintering, a part of the macromolecular material is decomposed and removed, and the other part of the macromolecular material and the carbon material together form the backbone structure and the pores. With the modified material and a high temperature, the nitrogen-containing functional group is then formed. Thus, properties including electrical conductivity, heat conductivity, reduction oxidation, ion reduction oxidation and catalytic efficiency of the nitrogen-containing porous carbon material can be enhanced, thereby allowing the nitrogen-containing porous carbon material to be more advantageous for applications.

2. In a conventional storage capacitor, as electrodes are not in form of a block material, the electrodes need to be applied to a metal collector plate to form a layer-like or plate-like structure and be used. Further, as increasing the thickness of such electrodes is not easy, the area of the electrodes is frequently increased as an alternative when electrodes having larger volumes are needed, meaning that the area of the metal collector plate also needs to be correspondingly increased. In comparison, the nitrogen-containing porous carbon material obtained by the present invention has rigidity and is in form of a block material. When the nitrogen-containing porous carbon material is applied as electrodes to a storage capacitor, the thickness may be increased to achieve a larger volume. Therefore, the areas of the first collector plate and the second collector plate used can be reduced to further decrease the amount of material used, thereby significantly reducing the utilization and costs of metal collector plates.

3. With the nitrogen-containing functional group included in the first nitrogen-containing porous carbon plate and the second nitrogen-containing porous carbon plate, a certain amount of pseudo-capacitance can be obtained to increase the storage capability.

What is claimed is:

1. A manufacturing method of a nitrogen-containing porous carbon material, comprising steps of:
S1: mixing a carbon material, a macromolecular material and a modified material into a preform, the modified material comprising nitrogen and being selected from the group consisting of amine, amide, a nitrogen-containing heterocyclic compound and an ammonium salt; wherein, in the preform, the weight percentage of the carbon material is between 30% and 85%, the weight percentage of the macromolecular material is between 10% and 60%, and the weight percentage of the modified material is between 3% and 40%;
S2: performing a formation process on the preform to obtain a formed body; and
S3: performing high-temperature sintering on the formed body, such that a part of the macromolecular material is decomposed and removed, one other part of the macromolecular material and the carbon material together form a backbone structure comprising a plurality of pores, and the nitrogen in the modified material becomes attached to the backbone structure to form a nitrogen-containing functional group to further obtain a nitrogen-containing porous carbon material.

2. The manufacturing method of a nitrogen-containing porous carbon material of claim 1, wherein in step S1, the carbon material is selected from the group consisting of carbon black, carbon fibers, carbon nanotubes, vapor grown carbon fibers, activated carbon, graphite, graphene, hollow carbon, soft carbon and hard carbon.

3. The manufacturing method of a nitrogen-containing porous carbon material of claim 1, wherein in step S1, the macromolecular material is selected from the group consisting of phenol formaldehyde resin, epoxy, polyacrylonitrile (PAN), furan resin, polyvinyl alcohol (PVA), polyvinyl chloride (PVC), cellulose, polyvinylidene fluoride (PVDF), polytetrafluoroethene (PTFE) and fluorinated ethylene propylene (FEP).

4. The manufacturing method of a nitrogen-containing porous carbon material of claim 1, wherein in step S2, the formation process causes the preform to be placed in a heating temperature between 100° C. and 200° C. and a formation pressure between 5 kgf/cm² and 200 kgf/cm².

5. The manufacturing method of a nitrogen-containing porous carbon material of claim 1, wherein in step S3, the high-temperature sintering causes the formed body to be placed in a heating temperature between 400° C. and 1200° C.

6. The manufacturing method of a nitrogen-containing porous carbon material of claim 1, wherein in step S3, the nitrogen-containing porous carbon material comprises a porosity rate between 10% and 85%.

7. The manufacturing method of a nitrogen-containing porous carbon material of claim 1, wherein in step S1, the amine is selected from the group consisting of propylamine, isopropylamine, hexylamine, octylamine, dodecylamine, 3-methyl-2-amino-pentane, ethylene diamine, aniline, toluidine, naphthylamine, biphenyl amine, benzidine, phenylene diamine, toluene diamine, and 2,6-toluene diamine.

8. The manufacturing method of a nitrogen-containing porous carbon material of claim 1, wherein in step S1, the amide is selected from the group consisting of as acetamide, urea, and acetanilide.

9. The manufacturing method of a nitrogen-containing porous carbon material of claim 1, wherein in step S1, the nitrogen-containing heterocyclic compound is selected from the group consisting of pyrrolidine, pyrrole, pyridine, hexahydro-pyridine, 4-amino-2-oxo-pyrimidine, 2,4-dioxypyrimidine, melamine, and 5-methyl-2, 4-dioxypyrimidine.

10. The manufacturing method of a nitrogen-containing porous carbon material of claim 1, wherein in step S1, the ammonium salt is selected from the group consisting of carbamate, ammonium bicarbonate, ammonium acetate, and sodium carbonate.

11. A nitrogen-containing porous carbon material manufactured by the manufacturing method of claim 1, comprising:
the backbone structure, mostly composed by carbon, comprising the pores; and
the nitrogen-containing functional group bound with the backbone structure.

12. The nitrogen-containing porous carbon material of claim 11, wherein the backbone structure has a porosity rate between 10% and 85%.

13. A storage capacitor for seawater, comprising a first nitrogen-containing porous carbon plate, a second nitrogen-containing porous carbon plate disposed at a distance from the first nitrogen-containing porous carbon plate, a first collector plate in contact with the first nitrogen-containing porous carbon plate, and a second collector plate in contact with the second nitrogen-containing porous carbon plate, the first nitrogen-containing porous carbon plate, the second nitrogen-containing porous carbon plate, the first collector plate and the second collector plate disposed in seawater, the first nitrogen-containing porous carbon plate and the second nitrogen-containing porous carbon plate manufactured by the manufacturing method of claim 1; wherein, sodium chloride in the seawater decomposes into sodium ions and chloride ions to respectively enter the first nitrogen-containing porous carbon plate and the second nitrogen-containing porous carbon plate to store energy.
